(19) United States
(12) Patent Application Publication
(10) Pub. No.: US 2014/0200920 A1
(43) Pub. Date: Jul. 17, 2014

(54) METHOD AND APPARATUS FOR ASSOCIATING PATIENT IDENTIFIERS UTILIZING PRINCIPAL COMPONENT ANALYSIS

(71) Applicant: MCKESSON FINANCIAL HOLDINGS, Hamilton (BM)

(72) Inventor: Arien Malec, Oakland, CA (US)

(73) Assignee: McKesson Financial Holdings, Hamilton (BM)

(21) Appl. No.: 13/852,782

(22) Filed: Mar. 28, 2013

Related U.S. Application Data
(60) Provisional application No. 61/751,606, filed on Jan. 11, 2013.

(51) Int. Cl. G06Q 10/06; G06Q 50/24

(52) U.S. Cl. CPC G06Q 10/06; G06Q 50/24
USPC 705/3

(57) ABSTRACT

A method, apparatus and computer program product are provided to associate patent identifiers, such as by matching patient identifiers, utilizing principal component analysis. In the context of a method and for each of a plurality of patient identifiers, a set of vectors is determined that is representative of a plurality of components of a respective patient identifier. The method also performs a principal component analysis of each set of vectors, compares results of the principal component analysis of each set of vectors and determines whether two or more of the patient identifiers are associated with a same patient based upon a comparison of the results of the principal component analysis of each set of vectors.

### CROSS-REFERENCE TO A RELATED APPLICATION

This application claims the benefit of U.S. Provisional Application No. 61/751,606, filed Jan. 11, 2013, which is incorporated by reference herein in its entirety.

### TECHNOLOGICAL FIELD

An example embodiment of the present invention relates generally to the association, e.g., matching, of patient identifying information and, more particularly, to the association of patient identifiers utilizing principal component analysis.

### BACKGROUND

Many patients have a variety of healthcare records maintained by the same or different healthcare providers. In this regard, each healthcare provider may maintain its own records of the patient's visits, treatments and the like. Each patient record generally includes identifiers, e.g., information, identifying the patient, such as by name, address or other demographic information.

In some instances, the healthcare records maintained by different healthcare providers may be reviewed in order to identify healthcare records of the different healthcare providers that are associated with the same patient. For example, a comprehensive healthcare record of a patient may be established by collecting the healthcare records of the patient maintained by the various healthcare providers. In order to ensure that the healthcare records are associated with the same patient, a number of identifiers that are associated with the respective patient may be reviewed and algorithmically matched. Various algorithmic matching techniques may be utilized including, for example, the determination of a matched score of patient name similarity based on edit distance or a matched score based on components of the address of the patient.

While such approaches may permit healthcare records of a patient to be matched in terms of being associated with the same patient, algorithmic matching techniques generally do not scale well to large data sets and may disadvantageously require substantial processing. Additionally, each set of identifying information of a patient that is considered requires separate algorithmic processing and weighting relative to the other identifiers that are considered, thereby further increasing the processing requirements and further reducing the scalability to large data sets.

### BRIEF SUMMARY

A method, apparatus and computer program product are provided in accordance with one embodiment to associate patient identifying information, such as patient identifiers, utilizing principal component analysis. By defining a higher dimensional space formed by the various components of patient identifying information, this identifying information may be matched such that patient records related to the same patient may be identified. By reducing the dimensionality of the higher dimensional space through creation of component scores, the method, apparatus and computer program product of an example embodiment may reduce the set of complete data to which more complete algorithmic methods may be used to associate, e.g., match, patient identifying information, such as patient identifiers, in a manner that is efficient in terms of the requisite processing resources and is readily scalable to large datasets.

In one embodiment, a method is provided that includes, for each of a plurality of patient identifying information, such as patient identifiers, determining a set of vectors representative of a plurality of components of a respective patient identifying information. The method of this embodiment also performs a principal component analysis of each set of vectors and compares results of the principal component analysis of each set of vectors. The method also determines whether two or more of the patient identifying information, such as patient identifiers, are associated with a same or similar patient based upon a comparison of the results of the principal component analysis of each set of vectors. In another embodiment, an apparatus comprising processing circuitry configured to perform comparable functionality is provided. In a further embodiment, a computer program product including at least one non-transitory computer-readable storage medium having computer-executable program code instructions stored therein that include program code instructions configured to perform comparable functionality is also provided.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment of the present invention; and

FIG. 2 is a flow chart illustrating the operations performed, such as by the apparatus of FIG. 1, in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

A method, apparatus and computer program product are provided in order to permit patient identifying information to be associated. Although described hereinbelow in conjunction with patient identifiers, the method, apparatus and computer program product of example embodiments of the present invention may also work with other types of patient identifying information, e.g., name, date of birth, zip code, etc. As such, the method, apparatus and computer program product of an example embodiment may permit healthcare records associated with the same patient to be matched based upon the patient identifiers of the various healthcare records. As described below, the method, apparatus and computer program product may utilize principal component analysis in order to permit the patient identifiers to be associated in a manner that is efficient in terms of the processing resources required. As such, the method, apparatus and computer program product of an example embodiment are more readily scalable to a large data set.

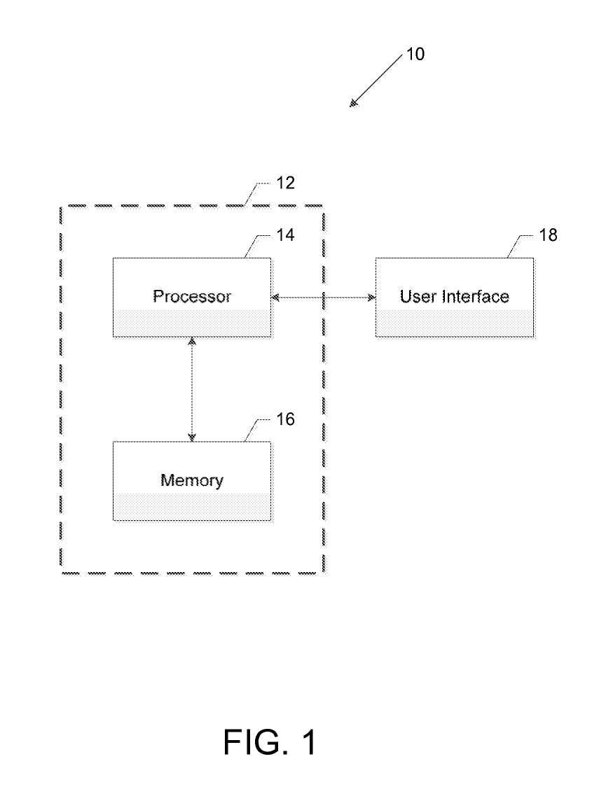

A computing device 10 may provide for the association of patient identifiers utilizing principal component analysis in accordance with an example embodiment of the present invention. The computing device may be embodied by one or more servers, computer workstations or the like. Regardless of the type of computing device, the computing device may be a centralized computing device or a distributed computing device. However, one example of a computing device is depicted in FIG. 1 and may be specifically configured to perform various operations in accordance with an example embodiment of the present invention as described below. It should be noted that some embodiments may include further or different components, devices or elements beyond those shown and described herein, such as a user interface.

As shown in FIG. 1, the computing device 10 may include or otherwise be in communication with a processing system including, for example, processing circuitry 12 that is configurable to perform actions in accordance with example embodiments described herein. The processing circuitry may be configured to perform data processing, application execution and/or other processing and management services. The processing circuitry may include a processor 14 and memory 16 that may be in communication with or otherwise control a communication interface 18.

The communication interface 18 may include one or more interface mechanisms for enabling communication with the other entities. In this regard, the communication interface may include, for example, an antenna (or multiple antennas) and supporting hardware and/or software for enabling the communications, such as secure communications as noted above.

In an example embodiment, the memory 16 may include one or more non-transitory memory devices such as, for example, volatile and/or non-volatile memory that may be either fixed or removable. The memory may be configured to store information, data, applications, instructions or the like for enabling the computing device 10 to carry out various functions in accordance with example embodiments of the present invention. For example, the memory could be configured to buffer input data for processing by the processor 12. Additionally or alternatively, the memory could be configured to store instructions for execution by the processor.

The processor 12 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 14 or otherwise accessible to the processor. As such, whether configured by hardware or by a combination of hardware and software, the processor may represent an entity (e.g., physically embodied in circuitry—in the form of processing circuitry) specifically configured to perform operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

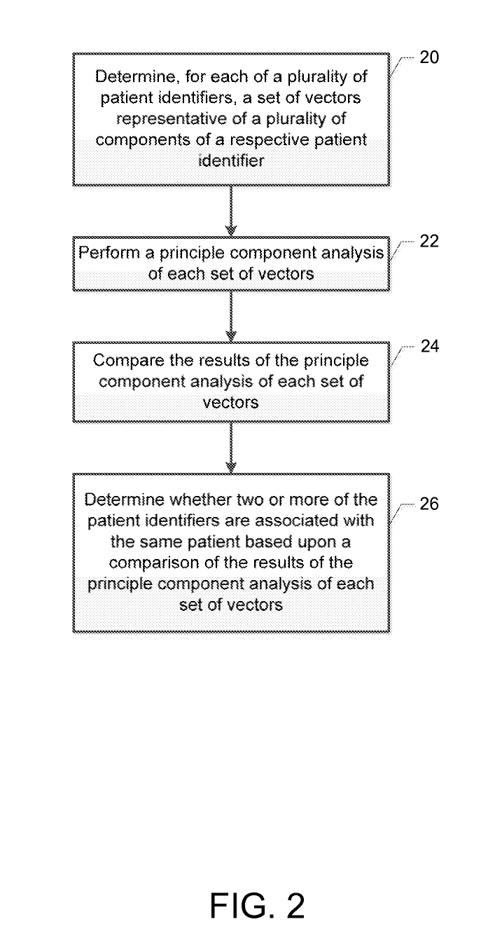

Referring now to FIG. 2, the operations performed by the computing device 10 of one embodiment are illustrated. In this regard, a healthcare record of a patient may include or otherwise be associated with a plurality of patient identifiers, such as basic patient identifiers such as the name of the patient, the age of the patient, the address of the patient, the social security number of the patient and/or other demographic information associated with the patient. Additionally, the patient identifiers may be derived from the basic patient identifiers, such as edit distance permutations and other transformations of the basic patient identifiers. As shown in block 20 of FIG. 2, the computing device, such as the processing circuitry 12 and, more particularly, the processor 14, may be configured to determine, for each of the plurality of patient identifiers included in or otherwise associated with a healthcare record of a patient, a set of vectors representative of a plurality of components of a respective patient identifier. Thus, the computing device, such as the processing circuitry, may be configured to determine a first set of vectors representative of a plurality of components of a first patient identifier of a respective healthcare record, a second set of vectors representative of a plurality of components of a second patient identifier associated with the respective healthcare record, a third set of vectors representative of a plurality of components of a third patient identifier associated with the respective healthcare record, and so on.

The computing device 10, such as the processing circuitry 12, e.g., the processor 14, may be configured to determine a set of vectors in various manners. In regards to a set of vectors associated with a patient's name, for example, the patient's first name may be represented by a 26-digit vector with each digit associated with a respective letter of the alphabet and the value of each digit representative of the number of occurrences of the respective letter of the alphabet within the patient's first name. Other vectors of the same set of vectors may be determined in the same fashion for the patient's middle name and the patient's last name in accordance with this example embodiment. This set of vectors is provided by way of example, however, and the computing device, such as the processing circuitry, e.g., the processor, may represent the various components of a respective patient identifier with different types of vectors in other embodiments. By way of another example, bigram vectors may be constructed for each of a plurality of patient identifiers, e.g., first name, middle name, last name, date of birth, etc.

The set of vectors representative of a plurality of components of a respective patient identifier may then be simplified by being decomposed into principal components. As shown in block 22 of FIG. 2, the computing device 10, such as the processing circuitry 12 and, more particularly, the processor 14, may be configured to perform a principal component analysis of the set of vectors representative of the plurality of components of a respective patient identifier. Principal component analysis is a mathematical procedure that utilizes an orthogonal transformation to convert a set of observations of possibly correlated variables, such as the set of vectors representative of a plurality of components of a respective patient identifier, to a set of values of linearly uncorrelated variables termed principal components. The number of principal components is less than or equal to the number of original variables. This transformation is defined so that the first principal component has the largest possible variance and each succeeding component has, in turn, the highest variance possible under the constraint that it be orthogonal to, that is, uncorrelated with, the preceding components.

The principal component analysis may be performed on the vectors representative of a plurality of components of all of the patient identifiers. Alternatively, the principal component analysis may be performed on the vectors representative of components of a subset of the patient identifiers, such as the patient identifiers that are most variable across the patient population and that accordingly contribute the greatest to the unique identification of a patient. For example, the feature space may include vector representations of name components, the edit distance of those name components, date of birth, edit distance of date of birth, etc. In this embodiment, the computing device 10, such as the processing circuitry 12 and, more particularly, the processor 14, may be configured to calculate a mean set of these features and may then rapidly calculate the difference from mean for each feature. As such, the vector representations may be transformed to a smaller dimensionality set of constituent features describing the greatest variation in the underlying data. These constituent features can be more quickly compared through principal component analysis than the underlying data.

As shown in block 24 of FIG. 2, the computing device 10, such as the processing circuitry 12 and, more particularly, the processor 14, may also be configured to compare the results of the principal component analysis of each set of vectors that were determined for the various patient identifiers of one healthcare record with the results of the principal component analysis of the sets of vectors that were determined for the various patient identifiers of other healthcare records. Although the results of the principal component analysis may be compared in various manners, the computing device, such as the processing circuitry and, more particularly, the processor, may determine if the results of the principal component analysis of the sets of vectors associated with the different healthcare records are sufficiently similar, such as by differing from one another by no more than a predefined threshold, by comparing the direction and magnitude of the vectors to predefined tolerances.

Thereafter, the computing device 10, such as the processing circuitry 12 and, more particularly, the processor 14, may be configured to determine whether two or more of the patient identifiers and, therefore, two or more of the healthcare records with which the patient identifiers are associated, are associated with the same patient based upon the comparison of the results of the principal component analysis of each set of vectors representative of the plurality of components of the respective patient identifiers of the different healthcare records. See block 26 of FIG. 2. In this regard, the computing device, such as the processing circuitry, may determine two or more of the healthcare records to be associated with the same patient in an instance in which the results of the principal component analysis of the sets of vectors associated with the different healthcare records are sufficiently similar, such as in an instance in which the results of the principal component analysis of a predetermined number of the sets of vectors associated with the different healthcare records are sufficiently similar.

As such, the computing device 10 and, therefore, the method, apparatus and computer program product of an example embodiment embodied by the computing device may identify two or more healthcare records that are associated with the same patient based upon an analysis of the patient identifiers of the healthcare records and, more particularly, based upon the determination and comparison of a set of vectors representative of a plurality of components of the patient identifier associated with each healthcare record. By utilizing principal component analysis, healthcare records associated with the same patient may be identified in a manner that is efficient in terms of the processing resources required for such a determination and, as such, may be more readily scalable to large data sets.

As noted above, FIG. 2 is a flowchart illustrating the operations performed by a method, apparatus and computer program product, such as computing device 10 of FIG. 1, in accordance with one embodiment of the present invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 16 of a computing device employing an embodiment of the present invention and executed by a processor 14 of the computing device. As will be appreciated, any such computer program instructions may be loaded onto a computer or other programmable apparatus (e.g., hardware) to produce a machine, such that the resulting computer or other programmable apparatus provides for implementation of the functions specified in the flowchart blocks. These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks. As such, the operations of FIG. 2, when executed, convert a computer or processing circuitry into a particular machine configured to perform an example embodiment of the present invention. Accordingly, the operations of FIG. 2 define an algorithm for configuring a computer or processing circuitry, e.g., processor, to perform an example embodiment. In some cases, a general purpose computer may be provided with an instance of the processor which performs the algorithm of FIG. 2 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions. In some embodiments, certain ones of the operations above may be modified or further amplified and additional optional operations may be included. It should be appreciated that each of the modifications, optional additions or amplifications below may be included with the operations above either alone or in combination with any others among the features described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
for each of a plurality of patient identifiers, determining a set of vectors representative of a plurality of components of a respective patient identifier;
performing a principal component analysis of each set of vectors;
comparing results of the principal component analysis of each set of vectors; and
determining whether two or more of the patient identifiers are associated with a same patient based upon a comparison of the results of the principal component analysis of each set of vectors.

2. A method according to claim 1 wherein determining a set of vectors comprises determining the set of vectors representative of the plurality of components of each of the plurality of patient identifiers associated with each of a plurality of healthcare records.

3. A method according to claim 2 wherein comparing the results of the principal component analysis comprises comparing the results of the principal component analysis of the set of vectors representative of the plurality of components of each of the plurality of patient identifiers associated with one healthcare record with the results of the principal component analysis of the set of vectors representative of the plurality of components of each of the plurality of patient identifiers associated with another healthcare record.

4. A method according to claim 3 wherein determining whether two or more of the patient identifiers are associated with the same patient comprises determining whether two or more of the patient identifiers are associated with the same patient based upon the comparison of the principal component analysis of each set of vectors associated with one healthcare record with the principal component analysis of each set of vectors associated with another healthcare record.

5. A method according to claim 4 wherein comparing the results of the principal component analysis comprises determining whether the results of the principal component analysis of the sets of vectors associated with two or more healthcare records differ by no more than a predefined threshold.

6. A method according to claim 5 wherein determining whether two or more of the patient identifiers are associated with a same patient comprises determining that patient identifiers associated with the two or more healthcare records are associated with the same patient in an instance in which the results of the principal component analysis are determined to differ by no more than the predefined threshold.

7. An apparatus comprising processing circuitry configured to:
for each of a plurality of patient identifiers, determine a set of vectors representative of a plurality of components of a respective patient identifier;
perform a principal component analysis of each set of vectors;
compare results of the principal component analysis of each set of vectors; and
determine whether two or more of the patient identifiers are associated with a same patient based upon a comparison of the results of the principal component analysis of each set of vectors.

8. An apparatus according to claim 7 wherein the processing circuitry is configured to determine a set of vectors by determining the set of vectors representative of the plurality of components of each of the plurality of patient identifiers associated with each of a plurality of healthcare records.

9. An apparatus according to claim 8 wherein the processing circuitry is configured to compare the results of the principal component analysis by comparing the results of the principal component analysis of the set of vectors representative of the plurality of components of each of the plurality of patient identifiers associated with one healthcare record with the results of the principal component analysis of the set of vectors representative of the plurality of components of each of the plurality of patient identifiers associated with another healthcare record.

10. An apparatus according to claim 9 wherein the processing circuitry is configured to determine whether two or more of the patient identifiers are associated with the same patient by determining whether two or more of the patient identifiers are associated with the same patient based upon the comparison of the principal component analysis of each set of vectors associated with one healthcare record with the principal component analysis of each set of vectors associated with another healthcare record.

11. An apparatus according to claim 10 wherein the processing circuitry is configured to compare the results of the principal component analysis by determining whether the results of the principal component analysis of the sets of vectors associated with two or more healthcare records differ by no more than a predefined threshold.

12. An apparatus according to claim 11 wherein the processing circuitry is configured to determine whether two or more of the patient identifiers are associated with a same patient by determining that patient identifiers associated with the two or more healthcare records are associated with the same patient in an instance in which the results of the principal component analysis are determined to differ by no more than the predefined threshold.

13. A computer program product comprising at least one non-transitory computer-readable storage medium having computer-executable program code instructions stored therein, the computer-executable program code instructions comprising:
for each of a plurality of patient identifiers, program code instructions configured to determine a set of vectors representative of a plurality of components of a respective patient identifier;
program code instructions configured to perform a principal component analysis of each set of vectors;
program code instructions configured to compare results of the principal component analysis of each set of vectors; and
program code instructions configured to determine whether two or more of the patient identifiers are associated with a same patient based upon a comparison of the results of the principal component analysis of each set of vectors.

14. A computer program product according to claim 13 wherein the program code instructions configured to determine a set of vectors comprise program code instructions configured to determine the set of vectors representative of the plurality of components of each of the plurality of patient identifiers associated with each of a plurality of healthcare records.

15. A computer program product according to claim 14 wherein the program code instructions configured to compare the results of the principal component analysis comprise program code instructions configured to compare the results of the principal component analysis of the set of vectors representative of the plurality of components of each of the plurality of patient identifiers associated with one healthcare record with the results of the principal component analysis of the set of vectors representative of the plurality of components of each of the plurality of patient identifiers associated with another healthcare record.

16. A computer program product according to claim 15 wherein the program code instructions configured to determine whether two or more of the patient identifiers are associated with the same patient comprise program code instructions configured to determine whether two or more of the patient identifiers are associated with the same patient based upon the comparison of the principal component analysis of each set of vectors associated with one healthcare record with the principal component analysis of each set of vectors associated with another healthcare record.

17. A computer program product according to claim 16 wherein the program code instructions configured to compare the results of the principal component analysis comprise program code instructions configured to determine whether the results of the principal component analysis of the sets of vectors associated with two or more healthcare records differ by no more than a predefined threshold.

18. A computer program product according to claim 17 wherein the program code instructions configured to determine whether two or more of the patient identifiers are associated with a same patient comprise program code instructions configured to determine that patient identifiers associated with the two or more healthcare records are associated with the same patient in an instance in which the results of the principal component analysis are determined to differ by no more than the predefined threshold.
